(19) United States
(12) Patent Application Publication
(10) Pub. No.: US 2013/0205903 A1
(43) Pub. Date: Aug. 15, 2013

(54) PHOTOACOUSTIC MEASURING DEVICE AND METHOD

(71) Applicant: Kenji Oyama, Tokyo (JP)

(72) Inventor: Kenji Oyama, Tokyo (JP)

(73) Assignee: CANON KABUSHIKI KAISHA, Tokyo (JP)

(21) Appl. No.: 13/879,890

(22) PCT Filed: Nov. 8, 2011
(86) PCT No.: PCT/JP2011/076127

§ 371 Date: Apr. 17, 2013

(30) Foreign Application Priority Data
Nov. 19, 2010 (JP) 2010-258498

(51) Int. Cl. G01N 29/24

(52) U.S. Cl. CPC G01N 29/2418
USPC 73/596

(57) ABSTRACT

The present invention provides a photoacoustic measuring device and a method by which the presence of an object can be easily identifyied in a relatively short time in photoacoustic measurement while holding an object by a holding plate. The photoacoustic measuring device has a irradiating unit with which the object is irradiated with light, a holding unit holding the object by the holding plate, a detecting unit detecting the photoacoustic wave generated by irradiating light and an analyzing unit analyzing photoacoustic signal of the photoacoustic wave. The analyzing unit analyzes a photoacoustic signal to acquire information concerning change of a signal intensity of a component of the photoacoustic signal of produced in an interface between the detecting unit and the holding plate and an interface between the holding plate and the object, to identify the presence of the object.

### TECHNICAL FIELD

The present invention relates to a photoacoustic measuring device and method of measuring a photoacoustic wave.

### BACKGROUND ART

Various proposals have so far been made for a technique of generating image data using light, and one of the proposals is a Photoacoustic Tomography (hereinafter “PAT”). PAT shows usability for diagnosis of skin cancer and breast cancer in particular, and receives an increasing expectation as a medical device in place of ultrasonic diagnostic devices, X-ray devices and MRI devices which were conventionally used for those diagnoses.

PAT visualizes in vivo information by measuring a photoacoustic wave, which is generated when a body tissues is irradiated with measuring beam such as visible light or near-infrared light and a light absorbing material inside the living body, particularly, the substance such as hemoglobin in blood, absorbs energy and instantaneously swell. This PAT technique enables quantitative and three-dimensional measurement of an optical energy absorption density distribution, that is, a density distribution of a light absorbing material in the living body.

Generally, benignancy and malignancy of breast cancer diagnosis in the department of mammary gland is comprehensively made based on a result of palpation or using a plurality of modalities as exemplified above. One of the critical grounds for this diagnosis is a diagnostic imaging result as to whether or not an angiogenesis generated by a cancer occurs. A photoacoustic image obtained from a breast cancer site, where the blood flow is increased compared to normal tissues due to the angiogenesis, potentially has better detectability than measurement using conventional ultrasonic diagnostic devices, X-ray devices and MRI devices. Further, since PAT uses light to generate diagnostic image data, it enables non-invasive diagnostic imaging without exposure to radiation, and consequently, it provides a greater advantage in terms of the burden of a patient, and it is expected for use in screening or early diagnosis of a breast cancer in place of X-ray devices of which repetitive use in diagnosis is seen to be difficult.

As for a technique of adequate detection of a photoacoustic wave, Patent Literature 1 and Patent Literature 2 propose techniques of identifying an attachment state of a device to an object. According to the technique disclosed in Patent Literature 1, by extracting the position of a body surface and the position of tissues in the living body from the resulting photoacoustic signal, it is possible to calculate the distance between the two extracted positions and decide an attachment state of a device to an object, based on this distance. Further, according to the technique disclosed in Patent Literature 2, by comparing the resulting photoacoustic signal and previous photoacoustic signals in a device which repeats photoacoustic measurement a plurality of times, it is possible to identify whether or not photoacoustic measurement is accurately performed, based on the change amount of a signal amplitude.

Generally, with a photoacoustic measuring device which generates three-dimensional photoacoustic image data by moving a light source and a probe along a holding plate to scan an object while holding the object by means of the holding plate, the rate that a scan time occupies in the time required for entire diagnosis is not small. When a scan area determined in the device is measured at a full size, a measuring operation of the entire scan area is conducted irrespectively of the presence of an object in a scanned area, and therefore a long time is uniformly required per diagnosis. At the same time, the object takes a load more than necessary. Therefore, there is a demand to reduce the scan time as much as possible. To reduce the scan time, it is effective to adapt the measuring operation to the object. Then, it is necessary to take a measure of identifying the presence of an object using, for example, an optical sensor or pressure sensor and controlling a scanning operation, or a measure of specifying an effective scan area in advance. However, when a method of using these measures is adotped, a new configuration is necessary, which makes the device larger. However, there is a request to remove these configurations as much as possible.

### CITATION LIST

### Patent Literature

PTL 1: Japanese Patent Application Laid-Open No. 2009-011555
PTL 2: Japanese Patent Application Laid-Open No. 2009-039264

### SUMMARY OF INVENTION

### Technical Problem

Patent Literatures 1 and 2 disclose methods using time out and a method of making identification by comparison with previous measurement results as a technique of identifying the presence of an object in generating photoacoustic image data. However, adaption of the measuring operation including scan to the presence of the object is not assumed. Further, the method using time out requires time to make identification, and the method of making comparison with previous measurement results requires multiple times of measurement for the identification. That is, it has been difficult to say that these related arts are sufficiently easy as techniques of identifying the presence of an object using a photoacoustic wave generated by irradiated light.

### Solution to Problem

In light of the foregoing, features of the photoacoustic measuring device according to the present invention which measures a photoacoustic wave generated by radiating light include the following configuration. The photoacoustic measuring device has: a irradiating unit which irradiates an object with light; a holding unit which holds the object by a holding plate; a detecting unit which detects the photoacoustic wave generated by the light irradiated from the irradiating unit; and an analyzing unit which analyzes the photoacoustic signal generated as a result of detecting the photoacoustic wave in the detecting unit, in which the analyzing unit analyzes the photoacoustic signal to acquire information concerning a change of signal intensity of a component of a photoacoustic signal of the photoacoustic wave produced in at least one of an interface between the detecting unit and the holding plate and an interface between the holding plate and object, and identify a presence of the object.

Further, in light of the foregoing, features of the photoacoustic measuring method according to the present invention of measuring a photoacoustic wave generated by radiating light include the following configuration. That is, the photoacoustic measuring method includes: irradiating an object held by a holding plate with light; detecting the photoacoustic wave generated by irradiating light using a detecting unit; and analyzing a photoacoustic signal generated as a result of detecting the photoacoustic wave, in which, in the analyzing, the photoacoustic signal is analyzed to acquire information concerning change of a signal intensity of a component of a photoacoustic signal of a photoacoustic wave produced in an interface between the detecting unit and the holding plate and an interface between the holding plate and the object, and identify a presence of the object.

### Advantageous Effects of Invention

According to the present invention, the photoacoustic measuring device which acquires a photoacoustic wave while holding an object by means of a holding plate identifies the presence of an object, based merely on signal characteristics of a photoacoustic signal to be detected, so that it is possible to easily make identification in a comparatively short time. Consequently, by, for example, adapting the measuring operation to the object according to a result of this identification, that is, controlling, for example, a scanning operation and an operation of processing a photoacoustic signal after photoacoustic measurement, it is possible to facilitate photoacoustic measurement.

### BRIEF DESCRIPTION OF DRAWINGS

FIG. 1 is a schematic view illustrating a configuration of a photoacoustic measuring system using a photoacoustic measuring device or method, according to a first embodiment of the present invention.

FIGS. 2A, 2B and 2C are conceptual diagrams describing a photoacoustic signal in a presence of an object, according to the first embodiment.

FIGS. 3A, 3B and 3C are conceptual diagrams describing a photoacoustic signal in an absence of an object, according to the first embodiment.

FIG. 4 is a conceptual diagram describing control of photoacoustic wave measurement, according to the first embodiment.

FIG. 5 is a flowchart illustrating the flow of generating photoacoustic image data, according to the first embodiment.

FIG. 6 is a schematic view illustrating a configuration of a photoacoustic measuring system using a photoacoustic measuring device or method, according to a second embodiment of the present invention.

FIGS. 7A, 7B and 7C are conceptual diagrams describing a photoacoustic signal in a presence of an object, according to the second embodiment.

FIGS. 8A, 8B and 8C are conceptual diagrams describing a photoacoustic signal in an absence of an object, according to the second embodiment.

FIGS. 9A, 9B, 9C and 9D are conceptual diagrams describing an example of a method of extracting an interfacial photoacoustic signal, according to the second embodiment.

FIG. 10 is a conceptual diagram describing control of photoacoustic wave measurement according to the second embodiment.

FIG. 11 is a flowchart illustrating the flow of generating photoacoustic image data according to the second embodiment.

### DESCRIPTION OF EMBODIMENTS

Features of the present invention include analyzing a photoacoustic signal of a photoacoustic wave detected by a detecting unit to acquire characteristics of the photoacoustic signal seen in the interface between the detecting section and holding plate and/or an interface between the holding plate and object, that is, information concerning a change of a signal intensity, to thereby identify the presence of an object. Based on this idea, the photoacoustic measuring device and method according to the present invention employ the basic configuration as described above. With the present invention employing this configuration, the detecting unit which is an electromechanical transducer can use any system (for example, a converting device using piezoceramic, a capacitance type Capacitive Micro-Machined Ultrasonic Transducer (CMUT), a Magnetic Micro-Machined Ultrasonic Transducer (MMUT) using a magnetic film or a Piezoelectric Micro-Machined Ultrasonic Transducer (for example, PMUT) using a piezoelectric thin film).

Hereinafter, embodiments of the present invention will be described with reference to the drawings.

### First Embodiment

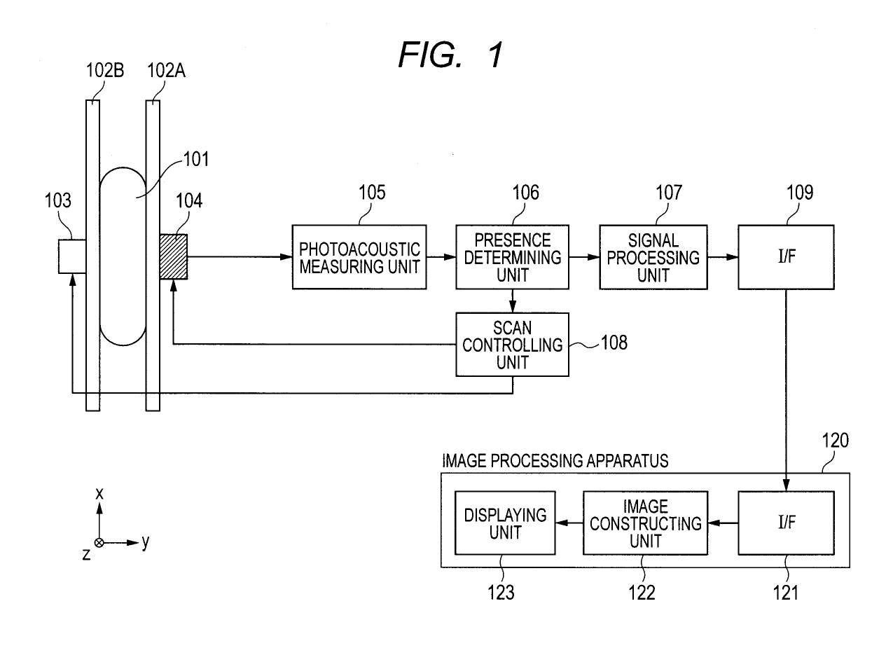

The first embodiment using a photoacoustic measuring device or method according to the present invention will be described with reference to the drawings. As illustrated in FIG. 1, a photoacoustic measuring system according to the first embodiment has a holding plate 102 which holds an object 101, an irradiating unit 103 which irradiates a measuring beam and a photoacoustic wave detecting unit 104 which includes acoustic wave detecting devices that form a detecting unit which detects a photoacoustic wave generated by irradiated light. Further, the photoacoustic measuring system has a photoacoustic measuring unit 105 which amplifies and converts a signal detected by the photoacoustic wave detecting unit 104 into a digital signal, a presence determining unit 106 which is a characteristic unit according to the present embodiment, and a signal processing unit 107 which performs, for example, recording processing of the detected photoacoustic signal. Further, the photoacoustic measuring system has a scan controlling unit 108 which two-dimensionally controls a scan position and an interface (hereinafter also referred to as “I/F”) 109 with an image processing unit 120 which is an external processing unit.

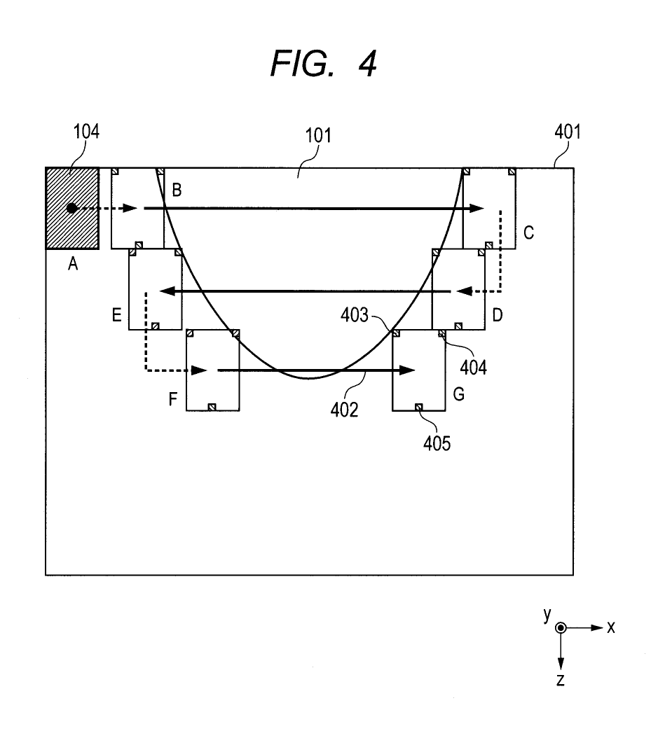

With the present embodiment, the presence determining unit 106 has an analyzing unit which analyzes a photoacoustic signal generated when the detecting unit detects a photoacoustic wave, and a control unit which controls the operation of performing photoacoustic measurement of an object according to the analysis result of the analyzing unit. The analyzing unit analyzes the photoacoustic signal to acquire information concerning signal intensity change of a component of the photoacoustic signal, which change being produced in at least one of the interface between the detecting unit and holding plate and the interface between the holding plate and object, to thereby identify the presence of an object. In the present invention, the presence of an object means whether or not there is the object in an area (the front face of the detecting unit) corresponding to the position of the detecting unit in a direction vertical to a detection face of the detecting unit (cephalocaudal axis direction, namely head-to-foot direction, when the object is a human body). That is, as illustrated in FIG. 4, when the object is projected and seen from the detecting unit side across the holding plate, if there is the object at the position of the detecting unit, “there is an object”, i.e., a presence of the object, and, when there is no object at the position of the detecting unit, “there is no object”, i.e. an absence of the object. Further, the control unit controls, through the scan controlling unit 108, a scan unit which moves the irradiating unit and the detecting unit to scan along the holding unit, and controls at least one of a scan speed, scan direction, position at which the detecting unit performs measurement and an interval for measurement in the detecting unit.

In FIG. 1, the object 101 of a measurement target is a breast in breast cancer diagnosis. The holding plate 102 which constitutes the holding unit is formed with a pair of two of a holding plate 102A on the side of the photoacoustic wave detecting unit 104 and a holding plate 102B on a side without the photoacoustic wave detecting unit 104, and a holding mechanism (not illustrated) controls the holding position of the holding plate 102 to change the holding gap and pressure. Hereinafter, when the holding plate 102A and holding plate 102B need not to be distinguished, they are collectively represented as the “holding plate 102.” By sandwiching and fixing the object 101 to the device by means of the holding plate 102, it is possible to reduce a measurement error produced when the object 101 moves. Further, it is possible to adjust the object 101 to the thickness appropriate for photoacoustic measurement according to the depth of penetration of a measuring beam. Since the holding plate 102 is positioned on an optical path of the measuring beam, it can have a high transmittance with respect to the measuring beam and, the holding plate 102A, particularly, is preferably made of a member which has high acoustic matching with an ultrasonic probe which is the detecting unit in the photoacoustic wave detecting unit 104. For example, a member such as polymethylpentene is used which is used in an ultrasonic diagnostic device.

The irradiating unit 103 which irradiates the object 101 with the measuring beam is a member for irradiating the object with light from a laser light source, and which includes, for example, a mirror which reflects light, a lens which condenses or expands light, and changes the shape of light, a prism which diffuses, refracts or reflects light, optical fibers which propagate light or a diffusing plate. Light irradiated from a light source can be guided to the object by an optical member such as a lens or mirror, and can be propagated by an optical member such as optical fibers. As long as these optical members can irradiate the object with a predetermined shape of light, any optical member may be used. The irradiating unit is provided with the scan unit to scan along the holding plate 102. The light source (not illustrated may be the one which emits pulse light (having the width equal to or less than 100 nsec) having the center wavelength in a near-infrared area of 530 nm to 1300 nm. For the light source, a solid-state laser which can emit a pulse having the center wavelength in the near-infrared area (for example, Yttrium-Aluminum-Garnet laser or Titan-Sapphire laser) is generally used. The wavelength of the measuring beam is selected between 530 nm and 1300 nm according to a light absorbing material (for example, hemoglobin, glucose or cholesterol) in the object 101 of the measurement target. For example, hemoglobin in a new blood vessel of a breast cancer of a measurement target generally absorbs light of 600 nm to 1000 nm and, by contrast with this, light absorption of water forming the living body becomes minimum at around 830 nm. Consequently, light absorption of the hemoglobin becomes relatively large at 750 nm to 850 nm. Further, the light absorption rate changes according to the state of hemoglobin (oxygen saturation), so that it may be possible to measure a functional change of the living body by comparing this change.

The photoacoustic wave detecting unit 104 has a probe which has a plurality of acoustic wave detecting devices that receive and convert photoacoustic waves produced in the object 101 into electrical signals (photoacoustic signals), and a scan unit which moves the probe to scan along the holding plate. To improve the S/N ratio of the photoacoustic signal, preferably the object 101 is irradiated with the measuring beam in the front face of the probe. Hence, the same scan controlling is performed at the same time for both the irradiating unit 103 and optical acoustic unit 104 such that those units are arranged at opposing positions and this positional relationship is kept. The photoacoustic measuring unit 105 which amplifies the photoacoustic signal inputted from the photoacoustic wave detecting unit 104 and converts into a digital signal has the following sub-units. That is, the photoacoustic measuring unit 105 has a signal amplifying unit which amplifies the analog signal outputted from the photoacoustic wave detecting unit 104, and an A/D converting unit which converts the analog signal into a digital signal. The signal amplifying unit performs control of increasing and decreasing the amplification gain with respect to the time the photoacoustic wave takes to reach the probe after the measuring beam is irradiated, to obtain a photoacoustic image having a uniform contrast irrespectively of a measurement depth.

The presence determining unit 106 which identifies the presence of an object 101 based on signal characteristics of the measured photoacoustic signal outputs the identification result to the signal processing unit 107 and scan controlling unit 108. The method of identifying the presence of the object 101 will be described below. The signal processing unit 107 which performs correction processing, recording processing and accumulating processing of the photoacoustic signal measured by the photoacoustic measuring unit 105 performs the following processing. That is, the signal processing unit 107 performs correction of sensitivity variation due to an individual difference of the acoustic wave detecting device of a probe, complementary processing of devices which are physically or electrically defective, processing of recording the photoacoustic signal in a recording medium (not illustrated) and accumulating processing for reducing noise. The accumulating processing is performed by repeating measuring the same portion of the object 101, and it sums and averages the measurement results to reduce system noise and improve the S/N ratio of the photoacoustic signal. Further, according to the identification result of the presence determining unit 106, when there is no object 101, the above processing is not executed.

The scan controlling unit 108, which controls the positions of the irradiating unit 103 and photoacoustic wave detecting unit 104 on the holding plate 102, two-dimensionally scans the object 101 and measures the object 101 at each scan position to enable even a small probe to obtain a wide measurement range. For example, in a breast cancer diagnosis, it is possible to measure a photoacoustic image of a full breast. According to the identification result of the presence determining unit 106, scan controlling by the scan controlling unit 108 is adjusted.

An I/F 109 which transmits processed photoacoustic data to the image processing unit 120 which is an external unit and an I/F 121 of the image processing unit 120 function as an interface of performing data communication between the photoacoustic measuring device and image processing unit 120. It is preferable to employ a communication standard which can secure real time processing and enables large-capacity transmission. The image processing unit 120 as an external unit constructs and displays a photoacoustic image based on processed photoacoustic data received from the photoacoustic measuring device, and it has an I/F 121, an image constructing unit 122 and a displaying unit 123 which displays a photoacoustic image. The image constructing unit 122 constructs photoacoustic image data from processed photoacoustic data. Generally, a device such as a personal computer or work station is used which has a high computation function or graphic display function. The I/F 121 of the image processing unit 120 has the same function as the I/F 109 of the photoacoustic measuring device, and in conjunction with the I/F 109, it transmits and receives, for example, data and a control command of the device. The image constructing unit 122 converts information of a photoacoustic characteristics distribution of the object 101 into an image and constructs photoacoustic image data, based on the received processed photoacoustic data. The image constructing unit 122 can also construct information which is more suitable for diagnosis by, for the constructed image data, adjusting the brightness, correcting distortion and applying various correction processings such as clipping of an area of interest.

With the photoacoustic measuring system employing the above configuration, by generating image data based on the photoacoustic effect, it is possible to convert the photoacoustic characteristics distribution of the object 101 into an image, and present the photoacoustic image. In addition, although, in FIG. 1, the photoacoustic measuring device and image processing device are configured as separate hardwares using the image processing unit 120 as an external unit, a configuration in which functions of the photoacoustic measuring unit and image processing unit are aggregated and integrated may also be adopted.

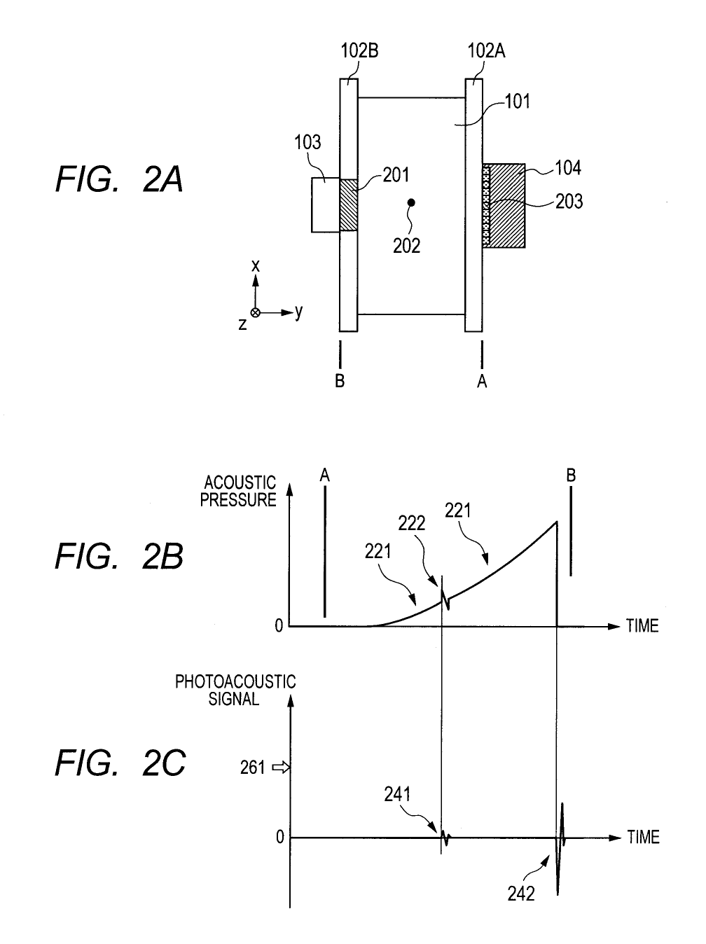

FIG. 2A illustrates a measuring method according to the present embodiment, FIG. 2B illustrates an acoustic pressure of the photoacoustic wave reaching the probe, and FIG. 2C illustrates an example of the detected photoacoustic signal. The vertical axes in FIGS. 2B and 2C indicate the acoustic pressure and photoacoustic signal, and the horizontal axes indicate the time. The internal tissue of the object 101 absorbs the measuring beam 201 and thermally swells, and emits a photoacoustic wave. The light absorbing material 202 in the object 101 (corresponding to a breast cancer cell in a case of breast cancer diagnosis) has a higher light absorption rate than the other tissues (hereinafter, “normal tissues”) (due to an increase in the flow rate of the angiogenesis in case of the breast cancer cell), and emits a photoacoustic wave having an acoustic pressure and signal component different from the normal tissues. One of the acoustic wave detecting devices 203 forming the probe of the photoacoustic wave detecting unit 104 detects the photoacoustic wave 222 in FIG. 2B emitted from the tissue of the object 101 irradiated with the measuring beam, and outputs a photoacoustic signal 241 in FIG. 2C. Since the detection frequency band of the acoustic wave detecting device is limited and the sensitivity at a low frequency is low, a signal from which a low frequency component is removed is formed as illustrated in FIG. 2C. In addition, the propagation speed of the measuring beam 201 which is light in the object 101 is relatively fast and, typically, the propagation speed of the photoacoustic wave 221 which is an ultrasonic wave in the object 101 is relatively slow, and therefore a photoacoustic wave produced at a point closer to the acoustic wave detecting device 203 (a point closer to a position A in FIG. 2A) is measured earlier and a photoacoustic wave produced at a point farther from the acoustic wave detecting device 203 (a point closer to a position B in FIG. 2A) is measured later. Therefore, it should be noted that the position A and position B are reversed between FIGS. 2A and 2B.

In FIG. 2B, the photoacoustic wave 221 emitted by the normal tissue of the object 101 mainly includes low frequency components. The measuring beam 201 irradiated on the object 101 by the irradiating unit 103 is strongly diffused in the object 101 and attenuates, and penetrates to the depth of the object 101 while decreasing its optical energy. Hence, a photoacoustic wave produced at a deeper position (a position closer to the holding plate 102A) has a lower acoustic pressure. The light absorbing material 202 which locally exists inside the object 101 emits an acoustic wave 222 mainly including high frequency components. The light absorbing material 202 is positioned at a relatively deep part of the object 101, and therefore energy of the measuring beam 201 incident on the light absorbing material 202 is small and the photoacoustic wave 222 also becomes small.

With the measuring method according to the present embodiment, in FIG. 2C, a photoacoustic signal 241 corresponding to the photoacoustic wave 222 from the light absorbing material 202 is detected as the first signal after detection of the photoacoustic wave is started. Then, the photoacoustic signal 242 corresponding to the photoacoustic wave from the interface between the holding plate 102B on the irradiating unit 103 side and object 101 is detected. Although the surface of the object 101 is formed with normal tissues of a relatively small light absorption rate, the measuring beam 201 is incident in a state where high optical energy is maintained, and the photoacoustic wave emitted by the surface of the object is large. Therefore, the photoacoustic signal 242 corresponding to the photoacoustic wave produced in the interface is a substantially large signal compared to a signal corresponding to the photoacoustic wave produced in the interface between the holding plate 102A on the probe side and object 101. Since the detection time of the signal 242 depends on a configuration of the device (the thickness of the holding plate 102A) and the signal intensity depends on the light absorption rate of the object 101, the signal 242 does not fluctuate per measurement and is detected with the same signal characteristics. To identify the presence of the object 101, a threshold 261 is set in advance such that the photoacoustic signal in case where there is the object does not include a signal component exceeding this threshold 261.

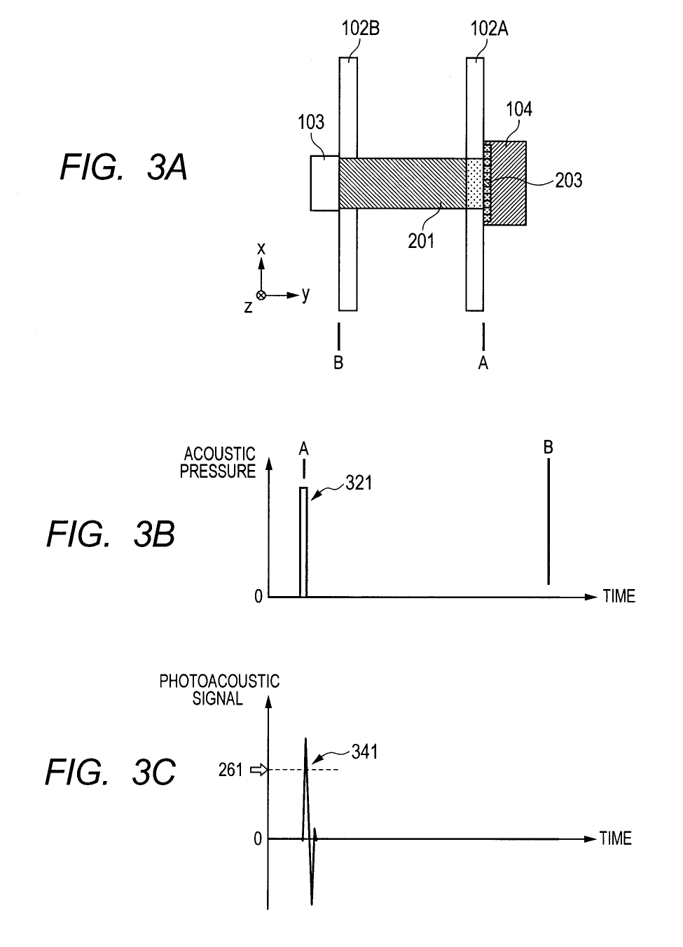

Next, illustrated in FIGS. 3A, 3B and 3C, the difference from the photoacoustic signal in case where there is no object 101 will be described. FIG. 3A illustrates a method of measuring a photoacoustic signal in an absence of the object 101, according to the first embodiment, FIG. 3B illustrates the acoustic pressure of the photoacoustic wave reaching the probe in this case and FIG. 3C illustrates an example of the photoacoustic signal detected in this case. Features of the present embodiment lie in identification based on recognition of this photoacoustic signal. The vertical axes in FIGS. 3B and 3C indicate the acoustic pressure and photoacoustic signal, and the horizontal axes indicate the time.

There is no object 101 and nothing which blocks the measuring beam 201, and the measuring beam 201 irradiated from the irradiating unit 103 directly reaches the probe of the opposing photoacoustic wave receiving unit 104. In FIG. 3B, a photoacoustic wave 321 emitted from the surface of the probe of the photoacoustic wave detecting unit 104 is detected. Generally, an acoustic matchingmember for improving the detection efficiency of the acoustic wave is attached to the surface of the probe. Since the acoustic matchingmember has a light absorption rate for the measuring beam 201, the surface of the probe serves as the acoustic source of the photoacoustic wave. When the surface of the probe is protected by a reflection film, the reflection film itself has the light absorption rate of several % (for example, about 3% in case of Au), and emits a great photoacoustic wave when receiving the measuring beam 201 having high optical energy.

In FIG. 3C, the photoacoustic signal 341 detected in the interface between the probe and holding plate 102A is detected in response to the photoacoustic wave 321. The signal 341 is generated from the photoacoustic wave on the surface of the probe, it is detected immediately after measurement is started, and it is substantially greater than the threshold 261. The signal 341 is a photoacoustic signal which depends on the structure of the probe, and hence the detection time and signal intensity do not fluctuate and are detected with the same signal characteristics. In other words, the detection time and signal intensity of the component of the photoacoustic signal of the photoacoustic wave produced in at least one of the interface between the detecting unit and holding plate and the interface between the holding plate and object are determined based on at least one of the positional relationship between the irradiating unit, holding plate, object and detecting unit, and light absorption characteristics thereof. By comparing the detected photoacoustic signal intensity and threshold 261, utilizing these signal characteristics, it is possible to obtain information concerning the change of the photoacoustic signal intensity and to identify the presence of the object 101. Although the presence of the photoacoustic signal 341 is detected in comparison with the threshold 261 to identify the presence of the object 101, it is also possible to identify the presence of the photoacoustic signal 242 in comparison with a separately set threshold to identify the presence of the object 101. Further, it is also possible to identify the presence of the object 101 by comparing both. Note that, considering the property of the object, the separately set threshold needs to be lower than the threshold 261.

As described above using FIG. 2C and FIG. 3C, the presence/absence of the object 101 produces the difference in the photoacoustic signal outputted from the acoustic wave detecting device 203. Consequently, the presence determining unit 106 can identify the presence of the object 101 based on the difference in signal characteristics.

FIG. 4 is a conceptual diagram describing control of photoacoustic wave measurement according to the first embodiment. A scan line 402 indicates a scan trajectory of the center of the probe of the photoacoustic detecting unit 104, and an arrow of the solid line indicates scan of an area in which there is the object 101 and an arrow of the broken line indicates scan of an area in which there is no object 101. To realize measurement of the full breast irrespective of the size object 101 (breast), the scan area 401 corresponding to an A4 size (about 300 mm×200 mm) of the full size is required. By repeating a measuring operation at each scan position along the scan line 402 on the scan area 401, it is possible to generate and display photoacoustic image data of the full breast. The probe of the photoacoustic wave detecting unit 104 includes a plurality of acoustic wave detecting devices which are two-dimensionally arranged, and can measure an area corresponding to the size of the probe at one time. Meanwhile, when, for example, the acoustic wave detecting device includes 30 devices in the horizontal direction and 40 devices in the vertical direction at the pitch of 1 mm, the size of the probe is 30 mm×40 mm and, therefore, measurement needs to be 50 times (10 times in the horizontal direction×5 times in the vertical direction) at minimum to measure the A4 full size. Further, when measurement is performed by overlapping measurement areas for accumulating processing, the number of measurements increases in proportion to the number of overlaps.

Focusing upon the scan line 402 in measurement of the full breast, there is at least a scan area in which there is no object 101 and which does not contribute to photoacoustic measurement, and the rate this scan area occupies in the entire scan area is not small. Therefore, when a measuring operation of the entire scan area is finished irrespectively of the presence of the object 101, a long time is uniformly required per photoacoustic measurement, and the subject has to take an unnecessary burden in proportion to this time. Hence, in the first embodiment, measurement control described below is performed. In FIGS. 4, 403, 404 and 405 denote acoustic wave detecting devices of interest when identifying the presence of the object 101 with measurement control according to the first embodiment. The devices-of-interest 403 and 404 are on the human body side of the breast as the object 101 and at both ends in the left-right axial direction of the human body, and are used to control scan in the horizontal direction (left-right axial direction). The device-of-interest 405 is on a side of the end of the object 101 and in the center of the left-right axial direction of the human body, and is used to control scan in the vertical direction in the detection face (the ventrodorsal axial direction of a human body).

In FIG. 4 for describing photoacoustic measurement control, a scan position A is the original point of scan, and, from this position, the photoacoustic detecting unit 104 starts scan. At the scan position A, since there is no object 101 (all devices-of-interest 403 to 405 do not recognize the object 101), it is assumed that the scan position A is not an area effective for photoacoustic diagnosis, a recording operation or signal processing of the photoacoustic signal which are performed after photoacoustic measurement are disabled. These processing are skipped until the object 101 is recognized. Between the scan positions A to B after horizontal scan is started, since the devices-of-interest 404 and/or 403 do not recognize the object, horizontal scan is continued. A scan position B indicates the position at which the device-of-interest 404 moves from an area in which there is no object 101 to an area in which there is the object 101. From the scan position B, since the devices-of-interest 404 and/or 403 recognize the object 101, it is assumed that the scan position B is an effective area for photoacoustic diagnosis, and the recording operation and signal processing of the photoacoustic signal are enabled. During horizontal scan between the scan positions B to C, all devices-of-interest 403 to 405 recognize the object.

A scan position C indicates the position at which the device-of-interest 403 moves from an area in which there is the object 101 to an area in which there is no object 101. At the scan position C, the device-of-interest 403 misses the object 101 in addition to the device-of-interest 404, and hence, it is assumed that the scan position C is not an effective area for photoacoustic diagnosis, and the recording operation and signal processing after photoacoustic diagnosis are disabled again. In addition, since the devices-of-interest 403 and/or 404 reach the area in which there is no object 101 after passing the area in which there is the object 101 during one horizontal scan, this one horizontal scan is finished without performing subsequent horizontal scanning.

Since the device-of-interest 405 recognizes the object 101 during horizontal scan from the scan positions B to C, it is assumed that the object 101 has an expansion in the vertical direction and, consequently, vertical scan is performed. A scan position D indicates a position at which the device-of-interest 403 moves from an area in which there is no object 101 to an area in which there is the object 101, and, since it is assumed that the scan position D is an effective area for photoacoustic diagnosis, the same measurement control as in the scan position B is performed. A scan position E indicates a position at which the device-of-interest 404 moves from an area in which there is the object 101 to an area in which there is no object 101. The device-of-interest 404 misses an effective area for photoacoustic diagnosis, and therefore finishes horizontal scan similar to the scan position C, and if an expansion of the object 101 in the horizontal direction is recognized, it performs vertical scan.

A scan position F indicates the position at which the device-of-interest 404 moves from an area in which there is no object 101 to an area in which there is the object 101. Since it is assumed that the scan position F is an effective area for photoacoustic diagnosis, the same control as in the scan position B is performed. A scan position G indicates the position at which the device-of-interest 403 moves from an area in which there is the object 101 to an area in which there is no object 101. Since the device-of-interest 403 misses an effective area for photoacoustic diagnosis, horizontal scan is finished similar to the scan position C. At the scan position G, since the device-of-interest 405 does not recognize the object 101 during horizontal scan from the scan position F to G, a further expansion of the object 101 in the vertical direction is not recognized. Hence, full scan for generating photoacoustic image data is finished then.

According to the above photoacoustic measurement control, the presence of the object is identified based on the photoacoustic signals detected by a plurality of acoustic wave detecting devices, thereby performing scan controlling and skipping a measuring operation in the scan area which does not contribute to photoacoustic diagnosis. Therefore, it is possible to reduce the entire measurement time.

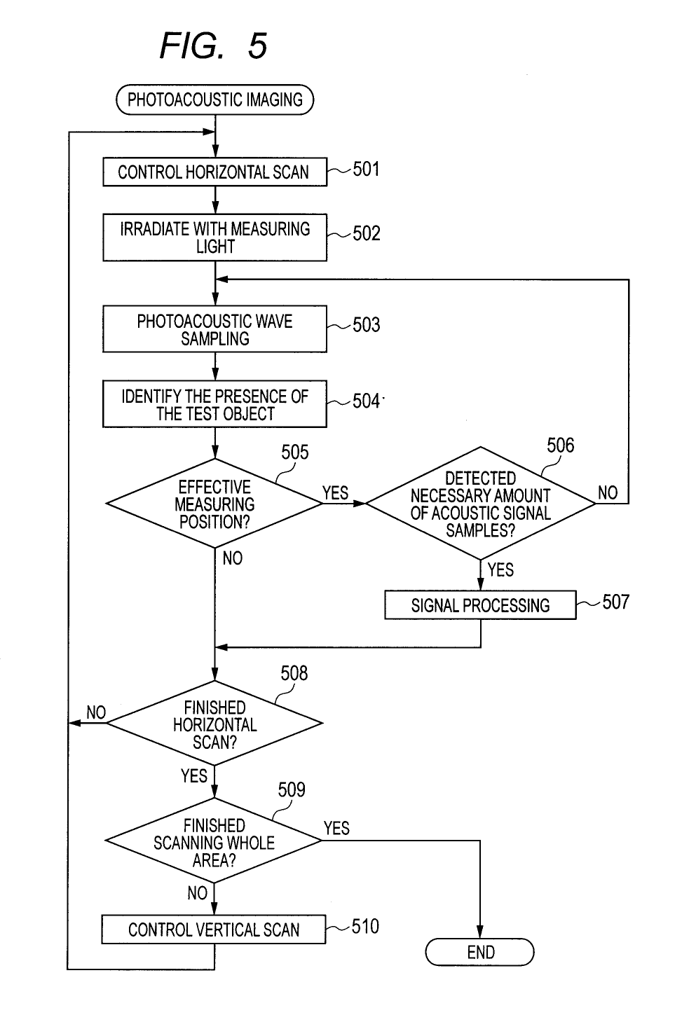

FIG. 5 is a flowchart of measurement of a photoacoustic wave according to the first embodiment. A series of processings in this flowchart are directed to functioning measurement control in FIG. 4, and obtaining a suitable photoacoustic image for diagnosis. In step 501, the scan controlling unit 108 performs horizontal scan controlling of the irradiating unit 103 and photoacoustic wave detecting unit 104 simultaneously to move to the next measurement position. In step 502, the irradiating unit 103 controls light emission of the light source and irradiates pulse laser light of the near-infrared area, which is a measuring beam, toward the object 101.

In step 503, the probe of the photoacoustic wave detecting unit 104 detects the photoacoustic wave produced as a result of the irradiation of the measuring beam in step 502, i.e. sampling. Further, the photoacoustic measuring unit 105 amplifies and A/D converts the photoacoustic signal detected by the photoacoustic wave detecting unit 104, and outputs this signal to the presence determining unit 106. In step 504, the presence determining unit 106 compares the signal intensities of the devices-of-interest 403, 404 and 405 with the threshold 261 set in advance for the photoacoustic signal inputted from the photoacoustic measuring unit 105, and identifies the presence of the object 101 at the position of each device. In the first embodiment, it is decided that there is no object 101 when the signal intensity exceeds the threshold 261.

In step 505, the presence determining unit 106 determines whether or not a current measurement position is an effective measurement position for photoacoustic diagnosis, based on the result of identifying the presence of the object 101 in step 504. When the measurement position is an effective measurement position, step 506 will follow. When the measurement position is not an effective measurement position, the presence determining unit 106 commands the scan controlling unit 108 to finish horizontal scan or full scan, and step 509 will follow. In step 506, the presence determining unit 106 identifies whether or not the photoacoustic measuring unit 105 detects the number of samples of photoacoustic signals required for one measurement. When detection of the required number of samples is finished, step 507 will follow. When detection is not yet finished, step 503 will follow and sampling is repeated to obtain photoacoustic signals aligned on the time axis. In step 507, the signal processing unit 107 performs correction of sensitivity variation of the acoustic wave detecting devices of the probe, complementary processing of devices which are physically or electrically defective, processing of recording the photoacoustic signal in a recording medium and accumulating processing of reducing noise.

In step 508, the scan controlling unit 108 identifies whether or not horizontal scan is finished. In this step, when a command to finish horizontal scan is received from the presence determining unit 106 or scan of the scan area at full size is finished, the scan controlling unit 108 identifies that horizontal scan is finished. When horizontal scan is finished, step 509 will follow. When horizontal scan is not finished, processing transitions to step 501 and photoacoustic measurement is repeated at the next measurement position. In step 509, the scan controlling unit 108 identifies whether or not full scan is finished. In this step, when a command to finish full scan is received from the presence determining unit 106 or full scan of the scan area at a full size is finished, the scan controlling unit 108 identifies that full scan is finished. When full scan is finished, a series of photoacoustic wave measuring operations will be finished. When full scan is not finished, processing transitions to step 510. In step 510, the scan controlling unit 108 simultaneously controls vertical scan of the irradiating unit 103 and photoacoustic wave detecting unit 104 to move a horizontal scan line to the next horizontal scan line, and continues the measuring operation.

According to the above processing, it is possible to provide capability of identifying the presence of the object based on the detected photoacoustic signal, and adapt the photoacoustic measuring operation to the shape of object 101. According to the present embodiment, in photoacoustic measurement for performing measurement with a configuration in which the light source and probe oppose to each other across the object while holding the object by means of the holding plate, it is possible to identify the presence of the object, based on change information of signal characteristics of the photoacoustic signal resulting from the presence of the object. Further, a new configuration such as an optical sensor or contact sensor for identifying the presence of the object are not necessary for realizing capability of identifying the presence of the object in one measurement. In addition, by adapting the photoacoustic measuring operation to the object based on the presence of the object, it is possible to reduce the entire photoacoustic measurement time.

### Second Embodiment

Next, a second embodiment for realizing the present invention will be described. According to the first embodiment, with a configuration where the light source and probe are arranged to oppose to each other across the object 101, and the probe is irradiated with the measuring beam 201 from the opposite side, the presence of the object 101 is identified. In contrast to this, features of the second embodiment include identifying the presence of an object similar to the first embodiment in a configuration where a light source and probe are arranged in the same direction and a measuring beam is irradiated from the same side, the side on which there is the probe. Further, by extracting a photoacoustic signal in the interface required to identify the presence of the object using signal characteristics of the photoacoustic signal, an accidental detection signal such as noise is removed. The second embodiment will be described mainly concerning the above features.

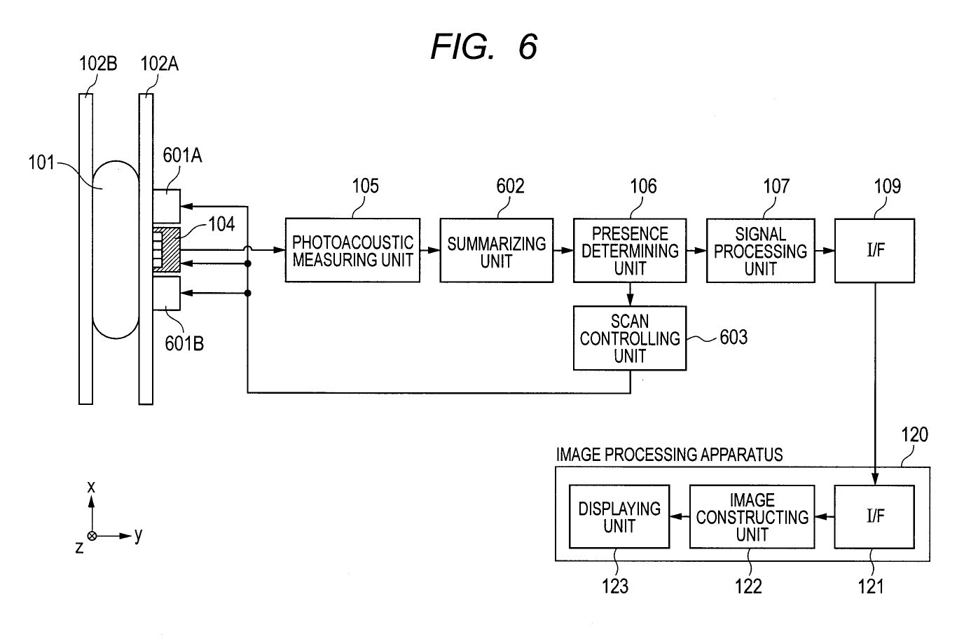

FIG. 6 is a schematic view illustrating a configuration of a photoacoustic measuring system according to the second embodiment. Compared to the configuration in FIG. 1 according to the first embodiment, a irradiating unit 601 is arranged on the same side as a photoacoustic wave detecting unit 104, a summing unit 602 is additionally provided and a scan controlling unit 603 has a different function from the first embodiment. In FIG. 6, the object 101 is irradiated with a measuring beam from the probe side by the irradiating unit 601. The irradiating unit 601 obliquely irradiates the measuring beam so as to illuminate the object 101 placed in the front face of the photoacoustic wave detecting unit 104. Further, a irradiating unit 601A and a irradiating unit 601B are symmetrically arranged across the photoacoustic wave detecting unit 104 such that the measuring beam is uniformly incident on the object. Hereinafter, when the irradiating unit 601A and irradiating unit 601B need not to be distinguished, they are collectively represented as the “irradiating unit 601”. While this symmetrical arrangement of the two irradiating units is preferable to realize uniform irradiation when the measuring beam is oblique incident, only one irradiating unit may be arranged or two irradiating units may be asymmetrically arranged.

The summing unit 602 which sums photoacoustic signals of a plurality of acoustic wave detecting devices forming the probe of the photoacoustic detecting unit 104 performs summarization to generate and extract an interfacial photoacoustic signal. The details will be described below. The scan controlling unit 603 controls the positions of the irradiating unit 601 and photoacoustic wave detecting unit 104 on the holding plate 102A. In this embodiment, the same scan controlling is simultaneously performed while keeping the positional relationship of the irradiating unit 601 and photoacoustic wave detecting unit 104 on the holding plate 102A. With a configuration of irradiating the measuring beam from the same side as the probe, the photoacoustic measuring system employing the above configuration can convert an optical characteristics distribution of the object 101 into an image and present a photoacoustic image by performing measurement based on the photoacoustic effect.

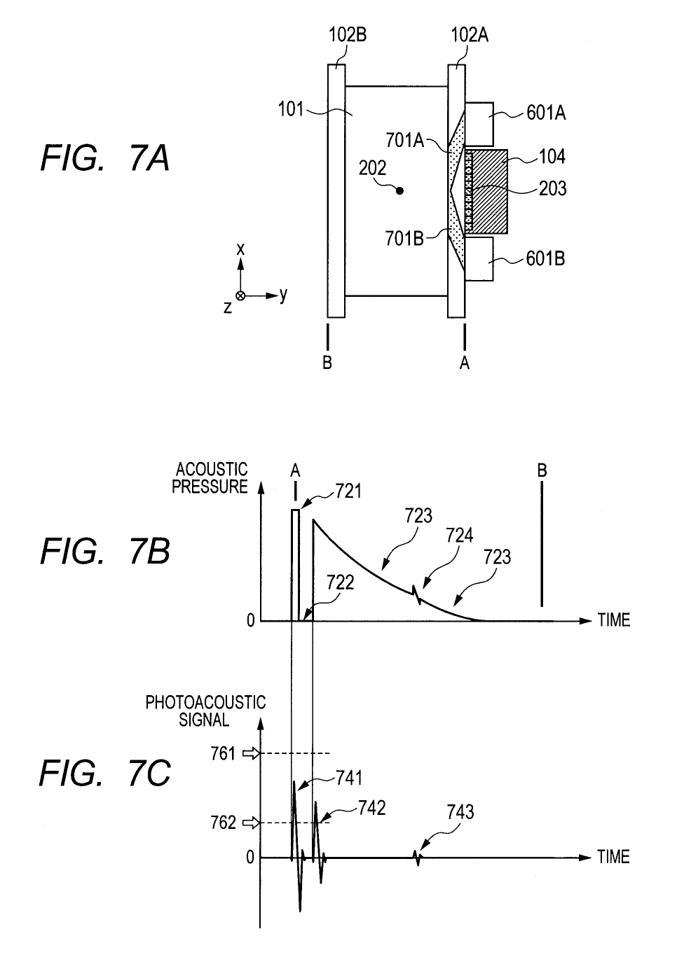

FIG. 7A illustrates a measuring method according to the present embodiment, FIG. 7B illustrates an acoustic pressure of the photoacoustic wave reaching the probe, and FIG. 7C illustrates an example of the detected photoacoustic signal. The vertical axes in FIGS. 7B and 7C indicate the acoustic pressure and photoacoustic signal, and the horizontal axes indicate the time. A measuring beam 701A and a measuring beam 701B obliquely irradiated by the irradiating unit 601 in FIG. 7 are irradiated from the radiating unit 601A and irradiating unit 601B, respectively, and are controlled to be irradiated simultaneously. Hereinafter, when the measuring beam 701A and measuring beam 701B need not to be distinguished, they are collectively represented as “measuring beam 701”.

In FIG. 7B, part of the obliquely irradiated measuring beam 701 is reflected on the interface between the holding plate 102A and object 101 and reaches the surface of the probe and, consequently, a photoacoustic wave 721 in which the surface of the probe is an acoustic source is detected. The holding plate 102 has a higher transmittance for the measuring beam 701, and therefore little photoacoustic wave 722 emitted from the holding plate 102A is produced. A signal width of the photoacoustic wave 722 corresponds to the thickness of the holding plate 102A. Then, the photoacoustic wave 723 emitted from the normal tissues of the object 101 and the photoacoustic wave 724 emitted by the light absorbing material 202 inside the object 101 are detected.

A configuration has been employed with the second embodiment where the measuring beam 701 is irradiated from the same side as the probe, so that, in FIG. 7C, the photoacoustic signal 741 detected in the interface between the probe and holding plate 102A in response to the photoacoustic wave 721 is measured as the first signal after detection of the photoacoustic wave is started. Since the photoacoustic wave produced in the surface of the probe by the measuring beam 701 maintaining high energy is directly detected, this is a relatively large signal. The photoacoustic signal 742 detected as the second signal indicates a photoacoustic signal detected in the interface between the holding plate 102A and object 101 in response to the photoacoustic wave 723. While the surface of the object 101 is formed with normal tissues of comparatively small light absorption rate, the measuring beam 701 is incident in a state where high optical energy is maintained, and therefore photoacoustic signal 742 corresponding to the photoacoustic wave 723 produced in this interface is larger than the following signal 743. The detection times of the signal 741 and signal 742 are determined according to the configuration of the device (thickness of the holding plate 102A) and the signal intensities of the signals 741 and 742 are determined according to the surface of the probe and the light absorption rate of the object 101, so that the signals do not fluctuate per measurements and are detected with the same signal characteristics.

FIG. 7C further illustrates the photoacoustic signal 743 of the light absorbing material 202 of the photoacoustic wave 724. To identify that there is no object 101, a threshold 761 is set in advance such that the photoacoustic signal, in case where there is an object, does not include a signal component exceeding this threshold. Further, to identify that there is the object 101, a threshold 762 is set in advance such that the photoacoustic signal, in case where there is an object, includes two signal components exceeding this threshold.

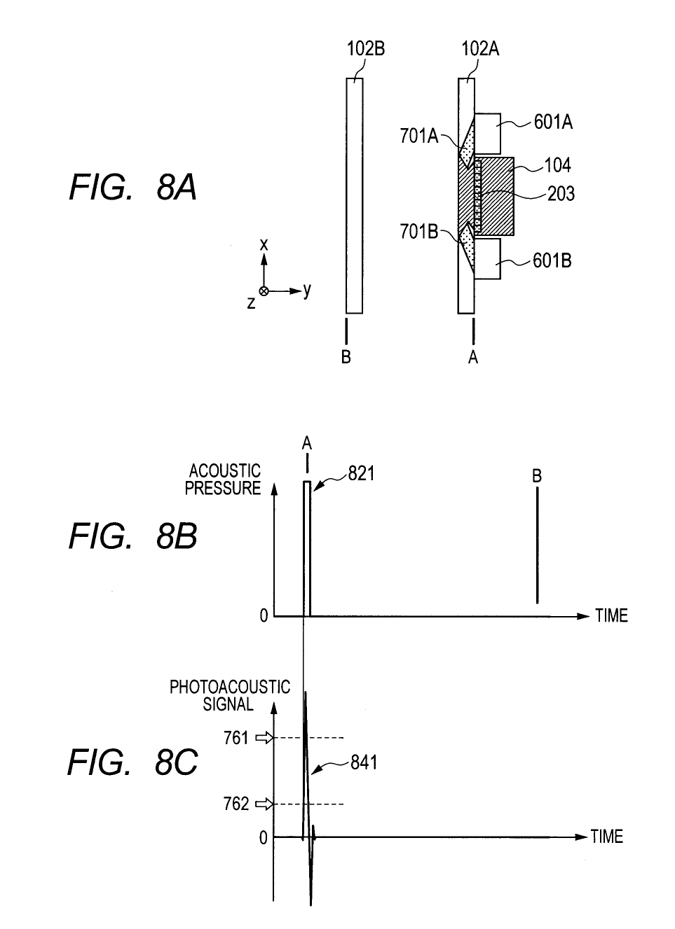

Next, the difference from the photoacoustic signal in case where there is no object 101, as illustrated in FIGS. 8A, 8B and 8C, will be described. FIG. 8A illustrates a method of measuring a photoacoustic signal when there is no object 101 according to the second embodiment, FIG. 8B illustrates the acoustic pressure of the photoacoustic wave reaching the probe in this case and FIG. 8C illustrates an example of the photoacoustic signal detected in this case. The vertical axes in FIGS. 8B and 8C indicate the acoustic pressure and photoacoustic signal, and the horizontal axes indicate the time.

In FIG. 8A, the measuring beam 701 irradiated from the irradiating unit 601 is incident on the interface between the holding plate 102A and air at an angle exceeding a critical angle. That is, the angle of oblique incidence from the irradiating unit according to the present embodiment is set not to exceed the critical angle when there is the object, and to exceed the critical angle when there is no object. Consequently, when there is no object, total reflection occurs, so that it is possible to prevent the measuring beam 701 which is laser light from being unnecessarily emitted to air. Further, FIG. 8B illustrates a photoacoustic wave 821 emitted from the surface of the probe. Total reflection allows the measuring beam 701 to reach the probe without loss of optical energy, thereby producing a substantially large photoacoustic wave compared to the photoacoustic wave 721 in case where there is the object 101. Further, FIG. 8C illustrates a photoacoustic signal 841 detected in the interface between the probe and holding plate 102A in response to the photoacoustic wave 821. The signal 841 is substantially larger than the above threshold 761. Since the signal 841 is a photoacoustic signal resulting from the positional relationship of the light source and probe, oblique incidence angle of the measuring beam 701, the thickness of the holding plate 102A and the structure of the probe, the detection time and signal intensity do not fluctuate and are detected with the same signal characteristics. By comparing the detected photoacoustic signal intensity and threshold 761 utilizing these signal characteristics, it is possible to identify the presence of the object 101.

A case has been described with FIGS. 7B and 8C and FIGS. 7C and 8C where, with the photoacoustic wave 721 and photoacoustic wave 821, and photoacoustic signal 741 and photoacoustic signal 841, the measuring beam 701 reflected on the interface between the holding plate 102 and the object 101 or air is incident on the probe. By contrast with this, when the reflected measuring beam 701 does not reach the surface of the probe, the measuring beam 701 becomes small or disappear, and hence it is difficult to use the measuring beam to identify the presence of the object. However, in this case, using the above threshold 762, it is possible to identify the presence of the object 101 based on the presence of the photoacoustic signal 742.

As described above, depending on the presence of the object 101, there is a substantial difference in characteristics of photoacoustic signals outputted from the photoacoustic wave detecting devices 203. In the second embodiment, the presence determining unit 106 identifies the presence of the object 101, based on change information of these signal characteristics.

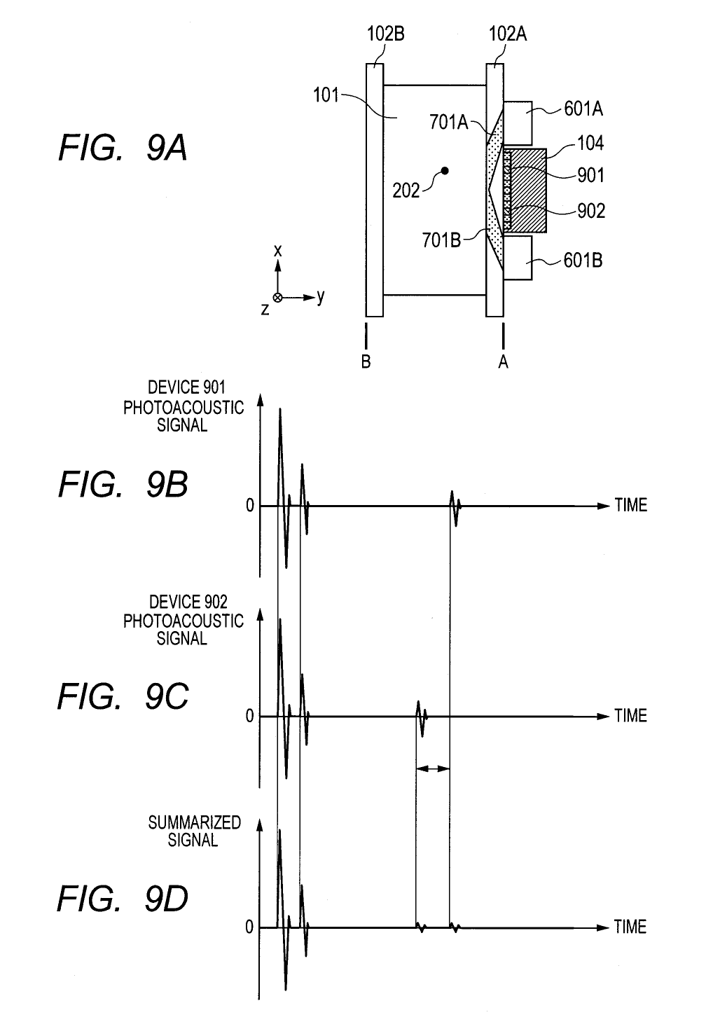

The above identification may be made based on information concerning change of characteristics of the interfacial photoacoustic signal outputted from one acoustic wave detecting device 203, or interfacial photoacoustic signals may be extracted from outputs of a plurality of acoustic wave detecting devices. FIG. 9A illustrates a measuring method of one example of a method of extracting an interfacial photoacoustic signal according to the present embodiment, FIGS. 9B and 9C illustrate the photoacoustic signals detected by the acoustic wave detecting device 901 and acoustic wave detecting device 902, and FIG. 9D illustrates a signal obtained by summing the signals in FIGS. 9B and 9C. The vertical axes in FIGS. 9B, 9C and 9D indicate the photoacoustic signal of device 901, photoacoustic signal of device 902 and summed signal, respectively, and the horizontal axes indicate the time.

In FIG. 9A, the positions of two acoustic wave detecting device 901 and acoustic wave detecting device 902 forming the probe of the photoacoustic wave detecting unit 104 are different, thereby producing difference according to the positional relationship in the photoacoustic signal. Upon comparison of FIGS. 9B and 9C, the detection time of the photoacoustic wave emitted by the light absorbing material 202 inside the object 101 varies between the two acoustic wave detecting device 901 and acoustic wave detecting device 902. This is because the spherical photoacoustic wave emitted by the light absorbing material 202 is detected at a different distance. In contrast to this, the detection times of the photoacoustic waves produced in the surface of the probe or the interface between the object 101 and holding plate 102 match between the two acoustic wave detecting device 901 and acoustic wave detecting device 902. This is because the distances to the interface between the probe and holding plate, and the interface between the holding plate and object 101, from the two acoustic wave detecting devices, are constant, and planar photoacoustic waves are detected at the same distance. When summing and averaging the photoacoustic signals detected by the acoustic wave detecting device 901 and acoustic wave detecting device 902 are performed, interfacial photoacoustic signals of the same detection time are summed and photoacoustic signals of the light absorbing material 202 of different detection times are not summed, so that signal characteristics as illustrated in FIG. 9D are obtained. That is, as a result of sum, it is possible to extract the photoacoustic signal produced in the interface.

Although cases have been described here where, for ease of description, photoacoustic signals of the two acoustic wave detecting device 901 and acoustic wave detecting device 902 are used, actually, by using signals of a greater number of detecting devices, more precise extraction of an interfacial photoacoustic signal is enabled. Further, in such a configuration it is possible to cancel noise which is accidentally produced in one device and, consequently, it prevents error determination due to noise and it provides capability of stably identifying the presence of an object. In the present embodiment, the above method of identifying the presence of an object is applied to the extracted interfacial photoacoustic signal.

As described above, by taking an advantage of characteristics that the photoacoustic wave produced in the interface is a planar wave, and extracting only a component of the interfacial photoacoustic signal required to identify the presence of an object and identifying the presence of an object, it is possible to reduce the influence of accidental noise and to provide capability of stable identification.

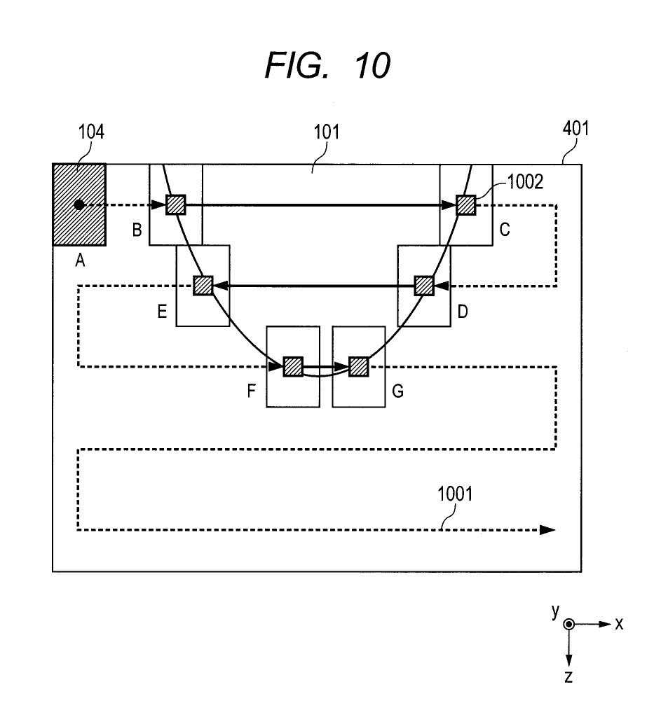

FIG. 10 is a conceptual diagram describing control of photoacoustic wave measurement according to the second embodiment. A scan line 1001 indicates a scan trajectory of the center of the photoacoustic detecting unit 104, and the arrow of the solid line indicates scan of an area in which there is the object 101 and the arrow of the broken line indicates scan of an area in which there is no object 101. With measurement control according to the second embodiment, an acoustic wave detecting device group (device group of interest) 1002 which is focused to identify the presence of the object 101 includes a plurality of acoustic wave detecting devices positioned in the center of the probe, and signals of the device group of interest 1002 are used to extract the interfacial photoacoustic signal.

The photoacoustic detecting unit 104 starts scanning from original point of scan (scan position A). At the scan position A, since there is no object 101 (all device groups-of-interest 1002 do not recognize the object 101), the recording operation and signal processing of the photoacoustic signal are skipped and the scan speed is increased. Between the scan positions A to B after horizontal scan is started, the device group-of-interest 1002 does not recognize an object, and hence the above horizontal scan is continued. The scan position B indicates the position at which the device group-of-interest 1002 transitions from an area in which there is no object 101 to an area in which there is the object 101. From the scan position B, since the device group-of-interest 1002 enters an area in which there is the object 101, it is assumed that the scan position B is an effective area for photoacoustic diagnosis, and the recording operation and signal processing of a photoacoustic signal are executed and the scan speed is decreased to a suitable speed for photoacoustic wave measurement.

The scan position C indicates the position at which the device group-of-interest 1002 transitions from an area in which there is the object 101 to an area in which there is no object 101. From the scan position C, since the scan position B misses the object 101, it is assumed that the scan position C is an effective are for photoacoustic diagnosis, and the recording operation and signal processing of a photoacoustic signal are skipped and the scan speed is increased to perform the same scan controlling as the scan position A. At the scan position D, since the device group-of-interest 1002 transitions from an area in which there is no object 101 to an area in which there is the object 101, it is assumed that the scan position D is an effective area for photoacoustic diagnosis, and the same measurement control as the scan position B is performed. Hereinafter, scan controlling and control such as signal processing are repeated based on an identification of the presence of the object 101 at each position to scan all scan areas 401.

According to the above photoacoustic measurement control, the presence of the object 101 is identifyied and the scan speed in the scan area which does not contribute to, photoacoustic diagnosis as in this embodiment, is increased, and thereby it is possible to reduce the entire measurement time. It should be noted that, since the device group-of-interest 1002 does not fully overlap the object 101 at the boundary part of the object, there is an area in which only part of devices forming the device group-of-interest 1002 recognize the object 101. In this case, since the extracted interfacial photoacoustic signal decreases as a result of sum, the above threshold 761 or 762 needs to be set while considering to which extent the boundary parts of the object are made an effective scan area.

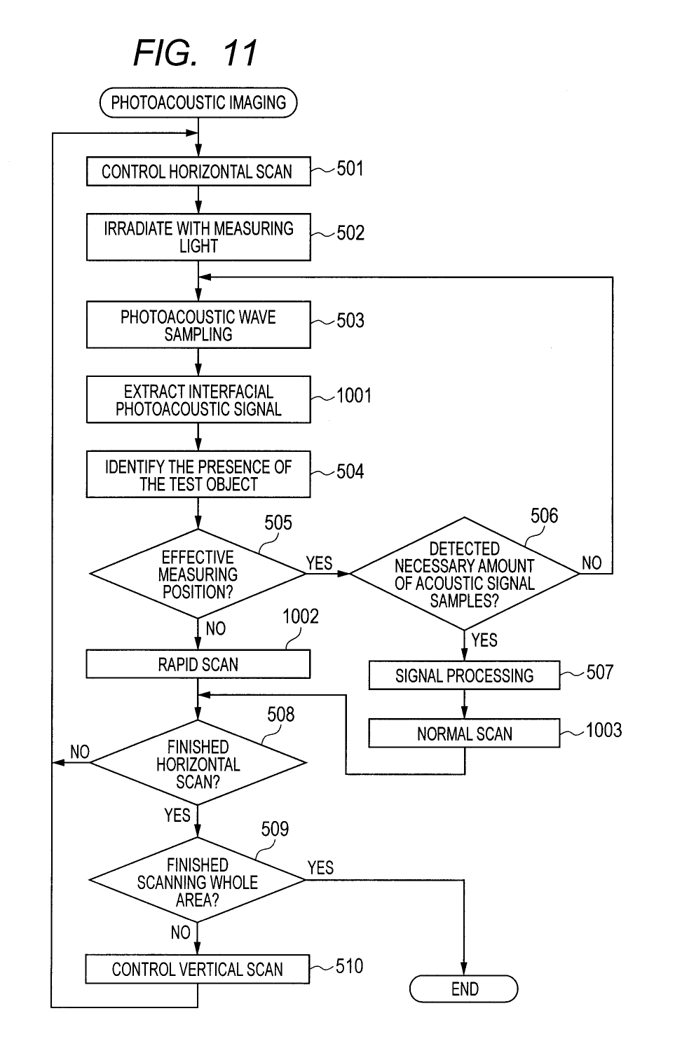

FIG. 11 is a flowchart illustrating the flow of measuring a photoacoustic wave according to the second embodiment. A series of processings in this flowchart are directed to functioning measurement control in FIG. 10, and obtaining a photoacoustic image suitable for diagnosis. In this flowchart, steps 1001 to 1003 are added to the flowchart in FIG. 5 of the first embodiment.

In step 1001, the presence determining unit 106 sums a photoacoustic signal of each acoustic wave detecting device forming the device group-of-interest 1002 to extract the interfacial photoacoustic signal. In step 1002, since it is decided in step 505 that there is no object at the current measurement position and the area is not effective for photoacoustic diagnosis, the scan speed is increased. In step 1003, since it is decided in step 505 that there is an object at the current measurement position and the area is effective for a photoacoustic diagnosis, the scan speed is controlled to a suitable scan speed for measurement of photoacoustic wave. According to the above processing, it is possible to provide capability of identifying the presence of the object based on the detected photoacoustic signal, and to adapt the photoacoustic measuring operation to the object 101.

According to the present embodiment, in a photoacoustic measurement of performing measurement with a configuration in which the light source and probe are arranged on the same side while holding the object by means of the holding plate, it is possible to identify the presence of the object based on the difference in signal characteristics of a photoacoustic signal produced depending on the presence of the object. Further, by utilizing characteristics included in an optical acoustic wave that a photoacoustic wave produced in the interface is a planar wave, to extract only an interfacial photoacoustic signal required to identify the presence of the object, it is possible to reduce the influence of accidental noise, and to provide capability of stably identifying the presence of the object.

### Third Embodiment

The purpose of the present invention can also be achieved by the following embodiment. That is, a storage medium (or recording medium) which stores a program code of software for realizing the function (particularly, the function of the presence determining unit forming an analyzing unit or control unit) of the above embodiments, is supplied to a system or device. Then, a computer (or Central Processing Unit (CPU) or Micro Processing Unit (MPU)) of the system or device reads and executes a program code stored in the storage medium. In this case, the read program code from the storage medium itself realizes the function of the above embodiments, and the storage medium which stores this program code configures the present invention.

Further, by executing the program code read by the computer, the operating system (OS) operating on the computer performs a part or all of actual processings based on the command of this program code. A case where the function of the above embodiments is realized by such processing is also included in the present invention. Further, the program code read from the storage medium can be written into a memory provided in a function extension unit connected to a computer or in a function extension card inserted in the computer. Then, the present invention includes that, based on the command of this program code, a CPU provided in this function extension card or function extension unit performs part or all of actual processings, and the function of the above embodiments are realized by these processings. When the present invention is applied to the above storage medium, the program code corresponding to the flowchart described above is stored in the storage medium.

### Other Embodiment

One of ordinary skill in the art can easily arrive at configuring a new system by adequately combining various techniques of the above embodiments, and, consequently, the system of these various combinations also belongs to the scope of the present invention. For example, examples described in the first and second embodiments are related to the cases where the present invention is applied to the photoacoustic measuring system in which the light source is arranged only on one side of the object and a measuring beam is only irradiated from one side to perform measurement. However, a configuration where light sources are arranged on both sides of the object and measurement is performed using measuring beams from the both sides is also possible for improving a measurement depth and obtaining a high contrast photoacoustic image. With this configuration, the change of characteristics of a photoacoustic signal due to the presence/absence of an object is represented by a combination of changes of signal characteristics according to the first embodiment and second embodiment, and this information of change can be used to identify the presence of the object. Consequently, a configuration of irradiating measuring beams on an object from both sides also belongs to the scope of the present invention. Further, a light guiding unit can be arranged by providing optical fibers so as to penetrate the photoacoustic detecting unit, and an object can be irradiated with a measuring beam from this light guiding unit to identify the presence of the above object, which embodiment also belongs to the scope of the present invention. Still further, although a configuration of identifying the presence of an object based on a photoacoustic signal digitized by A/D conversion has been described, if a photoacoustic signal having a sufficient S/N ratio can be detected, detection may be made based on an analog signal before the A/D conversion.

Further, examples of photoacoustic measurement control have been described in the first and second embodiments where recording and signal processing of a photoacoustic signal are skipped according to the presence of the object, and the scan direction or scan speed is controlled. In addition to the configurations, a measurement position or measurement interval (frame rate in photoacoustic measurement) can be controlled to adapt a measuring operation to a shape of an object. Further, a diagnostic device which has a plurality of modality functions which enable, for example, ultrasonic measurement and photoacoustic measurement simultaneously may employ a configuration of controlling other diagnostic functions according to a photoacoustic identification of the presence of an object.

This application claims the benefit of Japanese Patent Application No. 2010-258498, filed Nov. 19, 2010, which is hereby incorporated by reference herein in its entirety.

1. A photoacoustic measuring device which measures a photoacoustic wave generated when light is irradiated, the photoacoustic measuring device comprising:
a irradiating unit which irradiates an object with light;
a holding unit which holds the object by a holding plate;
a detecting unit which detects the photoacoustic wave generated by the light irradiated from the irradiating unit; and
an analyzing unit which analyzes the photoacoustic signal generated as a result of detecting the photoacoustic wave in the detecting unit,
wherein the analyzing unit analyzes the photoacoustic signal to acquire information concerning a change of signal intensity of a component of a photoacoustic signal of the photoacoustic wave produced in at least one of an interface between the detecting unit and the holding plate and an interface between the holding plate and object, and identify a presence of the object.

2. The photoacoustic measuring device according to claim 1, further comprising a control unit which controls an operation of photoacoustic measurement of an object using to an analysis result of the analyzing unit.

3. The photoacoustic measuring device according to claim 1, wherein
the detecting unit comprises a plurality of acoustic wave detecting elements,
the photoacoustic measuring device further comprises a summing unit which sums photoacoustic signals of photoacoustic waves detected by at least a part of the plurality of acoustic wave detecting elements, and generates a summed signal, and
the analyzing unit analyzes the summed signal generated by the summing unit.

4. The photoacoustic measuring device according to claim 1, wherein
a detection time and a signal intensity of the component of the photoacoustic signal of the photoacoustic wave produced in at least one of an interface between the detecting unit and the holding plate and an interface between the holding plate and the object is determined based on at least one of a positional relationship of the irradiating unit, the holding plate, the object and the detecting unit and light absorption characteristics of the irradiating unit, the holding plate, the object and the detecting unit, and
the analyzing unit identifies the presence of the object based on a change of an intensity of the photoacoustic signal of the photoacoustic wave produced in the interface, which change depending on the presence of the object.

5. The photoacoustic measuring device according to claim 1, further comprising a signal processing unit which controls at least one of correction processing of correcting an individual difference of the detecting unit, complementary processing of physically or electrically defective devices of the detecting unit, recording processing of a photoacoustic signal, accumulating processing of the photoacoustic signal for reducing noise.

6. The photoacoustic measuring device according to claim 1, further comprising a scan unit which moves the irradiating unit and detecting unit to scan along the holding unit, wherein the control unit controls the scan unit to control at least one of a scan speed, a scan direction, a measurement position of the detecting unit and an interval for measurement by the detecting unit.

7. A photoacoustic measuring method of measuring a photoacoustic wave generated when light is irradiated, the photoacoustic measuring method comprising:
irradiating an object held by a holding plate with light;
detecting the photoacoustic wave generated by irradiating light using a detecting unit; and
analyzing a photoacoustic signal generated as a result of detecting the photoacoustic wave,
wherein, in the analyzing, the photoacoustic signal is analyzed to acquire information concerning change of a signal intensity of a component of a photoacoustic signal of a photoacoustic wave produced in an interface between the detecting unit and the holding plate and an interface between the holding plate and the object, and identify a presence of the object.

8. The photoacoustic measuring method according to claim 7, further comprising controlling an operation for photoacoustic measurement of the object according to a result of the analyzing.
